(19) United States
(12) Patent Application Publication
(10) Pub. No.: US 2010/0321476 A1
(43) Pub. Date: Dec. 23, 2010

(54) CAMERA FOR CAPTURING THREE-DIMENSIONAL IMAGES

(75) Inventors: Juan Martinez, Hewitt, NJ (US); Andrew Berger, Pearl River, NY (US)

Correspondence Address: RAYMOND R. MOSER JR., ESQ.;MOSER IP LAW GROUP, 1030 BROAD STREET, SUITE 203, SHREWSBURY, NJ, 07702, US

(73) Assignees: SONY CORPORATION, Tokyo (JP); SONY ELECTRONICS INC., Park Ridge, NJ (US)

(21) Appl. No.: 12/487,459

(22) Filed: Jun. 18, 2009

(51) Int. Cl. H04N 13/02

(52) U.S. Cl. 348/49; 348/E13.074

(57) ABSTRACT

A camera for obtaining a three-dimensional image. The camera includes a lens module for capturing a beam of light, a filter module for polarizing the beam of light into a first polarized beam of light and a second polarized beam of light, a polarization array for generating a combined beam of light, one or more imagers for capturing the first polarized beam of light and the second polarized beam of light and an output module for processing and separating the mixed polarization image to produce the three-dimensional image. The imager further comprises one or more first polarized pixels for capturing the first polarized beam of light and one or more second polarized pixels for capturing the second polarized beam of light.

### BACKGROUND

1. Field of the Invention

Embodiments of the present invention generally relate to three-dimensional imaging systems and, more particularly, to an apparatus for obtaining three-dimensional stereoscopic images.

2. Description of the Related Art

With the increased popularity of digital cameras in the consumer marketplace, great advancements have resulted in stereo imaging and video processing. These cameras capture still images as well as moving, or video, images.

The term “stereo imaging” involves capturing of two images of a scene to simulate the process by which the brain perceives three-dimensional objects. To perceive the depth dimension of an image, the brain relies on the horizontal displacement of images provided by both eyes to create parallax (the apparent displacement of an object when viewed along two different lines of sight). The brain is able to merge the two images to perceive this parallax as the dimension of depth. This allows a person to see an object as solid in three spatial dimensions, such as width, height, and depth (i.e. x, y and z).

Conventionally, there exist various techniques for capturing high definition stereo images. However, in existing techniques two separate cameras and/or lenses are utilized for obtaining the high definition stereo images. For example, a particular scene is captured by such cameras using two exposures, the exposures being made from two different viewpoints. Such cameras need to be identical to each other in terms of type and settings to prevent mismatching of the images, which is difficult and time consuming to achieve. Furthermore, the simultaneous use of two separate cameras decreases reliability and usability while increasing the cost and weight of imaging devices.

Therefore, there is a need in the art for an efficient camera for obtaining three-dimensional stereoscopic images.

### SUMMARY OF THE INVENTION

Embodiments of the present disclosure generally relate to a camera for obtaining a three-dimensional image. In one embodiment, the camera for obtaining the three-dimensional image includes a lens module for capturing a beam of light, a filter module for polarizing the beam of light into a first polarized beam of light and a second polarized beam of light, a polarization array for generating a combined beam of light, the combined beam of light having the first polarized beam of light and the second polarized beam of light, one or more imagers for capturing the first polarized beam of light and the second polarized beam of light from the combined beam of light and an output module for processing, and separating the mixed polarization image to produce the three-dimensional image. The one or more imagers further comprises one or more first polarized pixels for capturing the first polarized beam of light and one or more second polarized pixels for capturing the second polarized beam of light, wherein the first polarized beam and the second polarized beam are orthogonally polarized and providing a mixed polarization image having a first polarized image and a second polarized image as a single output.

In another embodiment, the camera for obtaining a three-dimensional image includes a lens module for capturing a beam of light, a filter module for polarizing the beam of light into a first polarized beam of light and a second polarized beam of light, a polarization array for generating a combined beam of light, the combined beam of light having the first polarized beam of light and the second polarized beam of light, one or more imagers for separating a left eye polarized image and a right eye polarized image from the beam of light and an output module for processing and encoding the separated left eye polarized image and the separated right eye polarized image to produce the three-dimensional image. The one or more imagers further comprises one or more left eye polarized pixels for capturing the left eye polarized image and one or more right eye polarized pixels for capturing the right eye polarized image, and providing the separated left eye polarized image to a first output and the separated right eye polarized image to a second output.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a camera for obtaining a three-dimensional image using one or more single output imagers, according to one or more embodiments of the present invention;

FIG. 2 is a block diagram of a camera for obtaining a three-dimensional image using one or more dual output imagers, according to one or more embodiments of the present invention; and

FIG. 3 illustrates a detailed construction for an imager having a single output according to one or more embodiments of the present invention; and

FIG. 4 illustrates a detailed construction for an imager having a dual output according to one or more embodiments of the present invention.

### DETAILED DESCRIPTION

As explained further below, various embodiments of the invention discloses a camera for obtaining a three-dimensional image. The camera primarily includes a lens module, a filter module, a polarization array, one or more imagers and an output module for obtaining the three-dimensional image. The lens module, the filter module and the polarization module in combination generates a combined beam of light having vertically polarized light and horizontally polarized light. The one or more imagers capture a vertically polarized image and a horizontally polarized image from the beam of light, wherein the imagers are comprised of one or more vertically polarized pixels for capturing the vertically polarized image and one or more horizontally polarized pixels for capturing the horizontally polarized image, and further provides a mixed polarization image having the vertically polarized image and the horizontally polarized image as a single output or as two different outputs. The output module for processing, and separating the mixed polarization image to produce the three-dimensional image.

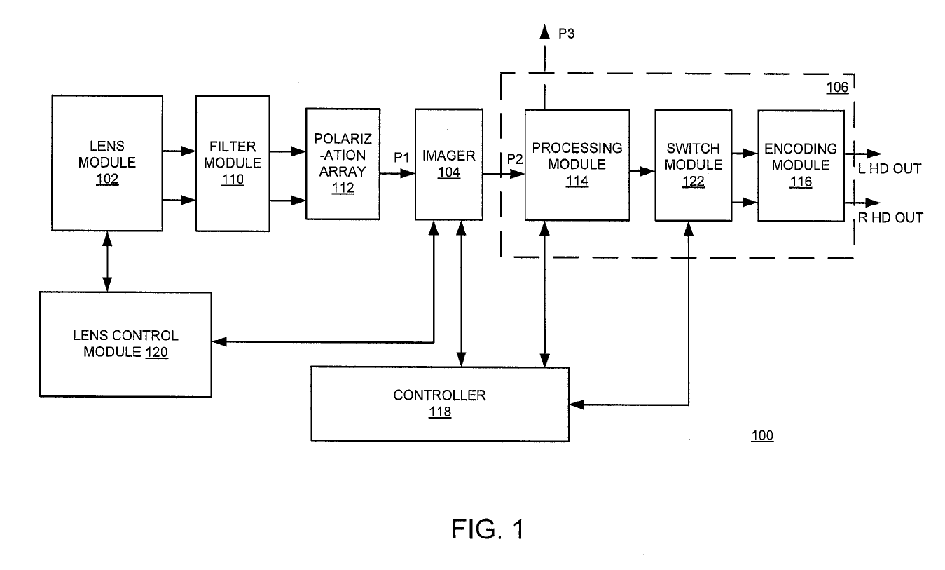

FIG. 1 is a block diagram of a camera 100 for obtaining a three-dimensional image using one or more single output imagers, according to one or more embodiments of the present invention. The camera 100 includes a lens module 102, a filter module 110, a polarization array 112, one or more imagers 104 and an output module 106.

The lens module 102 captures a beam of light or images for a left eye and a right eye respectively. The beam of light is captured from two different viewpoints that are horizontally displaced from each other. In some embodiments, the horizontal displacement between the two viewpoints is approximately 65 mm, an average distance between a person's eyes. In one embodiment, the lens module 102 may include a left lens and right lens for capturing the beam of light for a left eye and a right eye respectively.

The filter module 110 convert the light received from the lens module 102 into a vertically polarized beam of light and a horizontally polarized beam of light. For the purpose of simplicity, the left beam is referred to as a vertical polarized beam and the right beam is referred to as a horizontally polarized beam, but one of ordinary skill in the art would recognize that any two polarizing filters offset by 90 degrees would suffice. Linear polarization techniques for converting the light into horizontal and vertical polarization are discussed by way of example and are not intended to limit the invention to such. Although vertically polarized light is generally discussed with reference to a left image and horizontally polarized light with a right image, either polarization would suffice for either image. One of ordinary skill would recognize that other polarization techniques, such as circular polarization using prisms (resulting in left eye and right eye polarized light), would result in equally valid embodiments of the present invention. Those skilled in the art will appreciate that various other polarization devices similar to the filter module 110 may be configured for utilizing various polarization techniques.

The polarization array 112 mixes and/or combines the vertically polarized light and the horizontally polarized light received from the filter module 110 to produce a combined beam of light. Although the two images are combined into a single beam of light, no compression or loss of resolution occurs due to the combined beam being the result of two orthogonally polarized beams of light. In some embodiments, the polarization array 112 may include one or more mirrors (not shown in FIG. 1) for mixing and/or combining the vertically polarized beam and the horizontally polarized beam to produce a single beam of light. In other embodiments, various lenses, prisms, and the like may be used to combine the beams into a single beam.

The one or more imagers 104 receive the combined beam of light (at P1) from the polarization array 112 and separate the beam of light into a vertically polarized image and a horizontally polarized image. The imagers may be implemented as an array using a prism for the purposes of color separation, or a single imager may be used. An embodiment using a single imager is discussed, but a person of ordinary skill in the art would recognize that it would be possible to implement an embodiment of the present invention using multiple imagers. The imager 104 includes one or more vertically polarized pixels for capturing the vertically polarized image and one or more horizontally polarized pixels for capturing the horizontally polarized image. In an embodiment, the imager 104 may include a filter for capturing the vertically polarized image by the one or more vertically polarized pixels and the horizontally polarized image by the one or more horizontally polarized pixels. In another embodiment, the vertically polarized pixels and the horizontally polarized pixels are distributed in equal half for each picture frame. The imager 104 may have one Correlated Double Sampling (CDS) analog output, such as a P2 according to an array of the vertically polarized pixels and the horizontally polarized pixels. In some embodiments, the imager 104 provides a mixed polarization image having the first polarized image and the second polarized image as a single output P2. Thus, the mixed polarization image having the vertically polarized image and the horizontally polarized image are generated using a single imager (i.e. the imager 104). In an embodiment, the imager 104 is capable of separating colors and vertically (V) and horizontally (H) polarized light into a mixed polarization image as a single output P2 for obtaining 3D images.

The output module 106 includes a processing module 114, a switch module 122 and an encoding module 116. The output module 106 is operatively coupled with the imager 104 for processing, separating and encoding the separated vertically polarized image and the separated horizontally polarized image that are received from the imager 104 (through the output P2) to produce the three-dimensional or stereoscopic images. The final output is in a form of a left high definition (L HD) image and a right high definition (R HD) image which may be broadcasted or stored for multiple purposes.

The processing module 114 processes the mixed polarization image received from the output P2. In an embodiment, the processing module 114 may include one or more Digital Signal Processing (DSP) controllers for processing the mixed polarization image received from the imager 104.

In alternate embodiments, the processing module 114 performs analog to digital conversion (A/D) on the mixed polarization image received from the imager 104. In an embodiment, the processing module 114 performs predetermined analog signal processing on analog image signal output (P2) from the imager 104. In some embodiments, during A/D conversion, analog R, G, and B image signal output from the imager 104 is converted into a digital image signal represented by a plurality of bits (e.g., 12 bits) on the basis of the timing pulse output from a timing control module (not shown).

In some embodiments, the imager may output data in a raw format. This format may bypass the processing module 114 and supply image data before any gamma or other corrections. Alternately, the processing module 114 may receive the raw data and output the data directly before any processing or correction via P3. This raw data may then be processed externally.

In an embodiment, the processing module 114 may further include a CDS module (not shown in FIG. 1), an Auto Gain Control module (not shown in FIG. 1), and a clamping module (not shown in FIG. 1).

In an embodiment, the CDS module may be utilized to detect only a desired signal component in a device, such as the imager 104 by removing, for example, fixed pattern noise, from a signal output from a unit pixel. For CDS, a difference between a reset signal and an image signal is determined. The reset signal is generated with a predetermined voltage level applied on the unit pixel. The image signal represents an intensity of light sensed by the unit pixel. Thus, the CDS is effective in reducing fixed pattern noise that is inherent in the unit pixels and also noise caused by characteristic differences between the unit pixels.

In some other embodiments, the processing module 114 may further include a black level correction module (not shown in FIG. 1), a white balance control module (not shown in FIG. 1), and a gamma correction module (not shown in FIG. 1) for applying a color correction, such as a black level correction, a white balance correction, and a gamma correction respectively on the mixed polarization image received from the imager 104. In an embodiment, the processing module 114 further performs predetermined signal processing on the image data output after the A/D conversion so as to generate an image file. Subsequently, each block of the processing module 114 performs processing thereof while accessing the image data stored in an image memory.

In an embodiment, the black level correction module corrects the black level of each of the R, G, and B digital image signals A/D-converted so that the black level becomes a reference black level.

In an embodiment, the white balance control module converts the level of each of the digital signals of R, G, and B color components on the basis of reference white in accordance with the type of light source. That is, the white balance control module performs white balance correction. More specifically, the white balance control module identifies a portion that is estimated to be white in the object image using the brightness and saturation on the basis of the reference WB correction data. Subsequently, the white balance control module then computes the average of each of the R, G, and B color components, the G/R ratio, and the G/B ratio in that portion. The white balance control module performs level correction using these values for R and B correction gains.

The gamma correction module corrects the gradation characteristic of the image data subjected to white balance adjustment. More specifically, the gamma correction module non-linearly converts the level of the image data for each of the color components and controls the offset using a pre-defined gamma correction table.

In some embodiments, the imager 104 and the processing module 114 are operatively coupled with a controller 118. In an embodiment, the controller 118 facilitates the processing module 114 to have identical and matched left and right performance. In another embodiment, the controller 118 controls various image capturing operations performed by the imager 104 and the processing module 114. In an embodiment, the controller 118 is any type of microcomputer that comprises a Central Processing Unit (CPU), various support circuits, and a memory. The controller 118 reads out application programs stored in a ROM and executes the program using the CPU. The CPU may comprise one or more commercially available microprocessors or microcontrollers that facilitate data processing and storage. Various support circuits facilitate operation of the CPU and may include clock circuits, buses, power supplies, input/output circuits and/or the like. The memory includes a Read Only Memory, Random Access Memory, disk drive storage, optical storage, removable storage, and the like.

The switch module 122 subsequently separates the mixed polarization image into the first polarized image and the second polarized image. The switch module 122 first receives the processed mixed polarization image from the processing module 114 and then converts the mixed polarization image into the first polarized image and the second polarized image to generate the three-dimensional image at the output. In an embodiment of the present invention, the first polarized image and the second polarized image are separated on a basis of time multiplexing. Those skilled in the art may utilize several other techniques for such separating the mixed polarization image into the first polarized image and the second polarized image.

The encoding module 116 encodes the separated vertically polarized image and the separated horizontally polarized image received from the switch module 122. In an embodiment, the encoding module 116 may include one or more HDSDI encoders for encoding the separated vertically polarized image and the separated horizontally polarized image received from the switch module 122. The encoder 116 generates a final output that is in a form of a left HD image and a right HD image which may be further broadcasted for decoding by media or transmission devices.

The imager 104 and the lens module 102 are operatively coupled with a lens control module 120. The lens control module 120 controls and then optimizes various stereoscopic effects by adjusting separation and convergence of the left lens and the right lens on receiving buffered feedback signals from the imager 104. In some embodiments, the stereoscopic effects may include adjustment for stereovision near and adjustment for stereovision far by optimizing the intraocular separation and convergence between the left lens and the right lens of the lens module 108. In an embodiment, the lens control module 120 is any type of microcomputer that comprises a CPU, various support circuits and a memory. The CPU may comprise one or more commercially available microprocessors or microcontrollers that facilitate data processing and storage. Various support circuits facilitate operation of the CPU and may include clock circuits, buses, power supplies, input/output circuits and/or the like. The memory includes a Read Only Memory, Random Access Memory, disk drive storage, optical storage, removable storage, and the like for storing a control program or for storing data relating to status information.

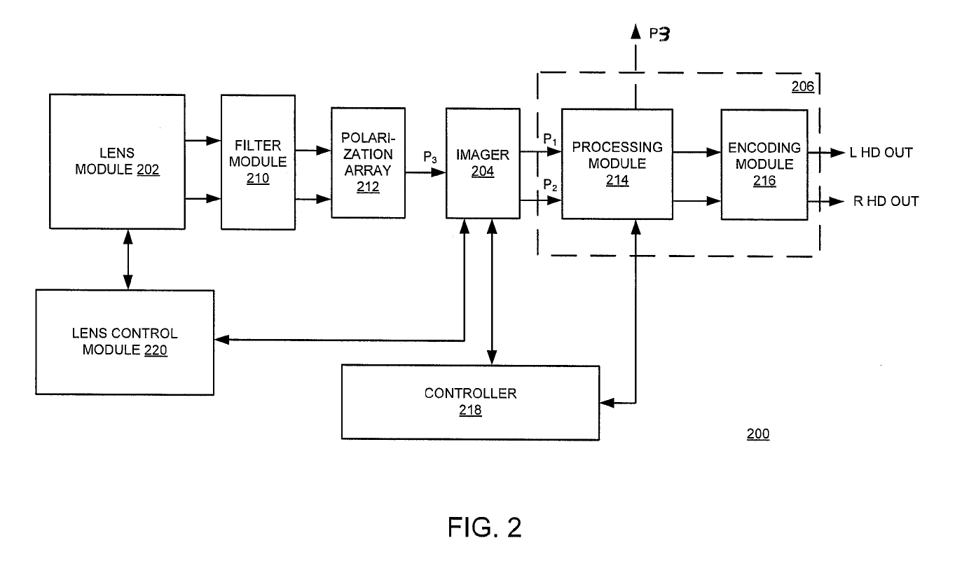

FIG. 2 is a block diagram of a camera 200 for obtaining a three-dimensional image using a dual output imager, according to one or more embodiments of the present invention. The camera 200 includes a lens module 202, a filter module 210, a polarization array 212, an imager 204 and an output module 206. The functionality of the lens module 202, the filter module 210 and the polarization array 212 is similar to that as described in the FIG. 1 above.

The imager 204 receives the combined beam of light (at P3) from the polarization array 212 and separates the beam of light into a vertically polarized image and a horizontally polarized image. The imager 204 includes one or more vertically polarized pixels for capturing the vertically polarized image and one or more horizontally polarized pixels for capturing the horizontally polarized image. In an embodiment, the imager 204 may include a filter for capturing the vertically polarized image by the one or more vertically polarized pixels and the horizontally polarized image by the one or more horizontally polarized pixels. In another embodiment, the vertically polarized pixels and the horizontally polarized pixels are distributed in equal half for each frame. The imager 204 may have two simultaneous CDS analog outputs, such as a first output P1 and a second output P2 according to an array of the vertically polarized pixels and the horizontally polarized pixels. In some embodiments, the imager 204 provides the vertically polarized image to the first output P1 and the horizontally polarized image to the second output P2. Thus, the vertically polarized image and the horizontally polarized image are generated using a single imager (i.e. the imager 204).

The output module 206 includes a processing module 214 and an encoding module 216. The output module 206 is operatively coupled with the imager 204 for processing and encoding the separated vertically polarized image and the separated horizontally polarized image that are received from the imager 204 (through the first output P1, and the second output P2) to produce the three-dimensional or stereoscopic images. The final output is in a form of a left eye high definition (L HD) image and a right eye high definition (R HD) image which may be broadcasted for multiple purposes.

The processing module 214 processes the vertically polarized image received from the first output P1 and the horizontally polarized image received from the second output P2. In an embodiment, the processing module 214 may include one or more dual channel DSP controllers for processing the vertically polarized image and the horizontally polarized image received from the imager 204.

In some embodiments, the imager 204 may output data in a raw format. This format may bypass the processing module 214 and supply image data before any gamma or other corrections. Alternately, the processing module 214 may receive the raw data and output the data directly before any processing or correction via P3. This raw data may then be processed externally.

The encoding module 216 encodes the processed vertically polarized image and the processed horizontally polarized image received from the processing module 214. In an embodiment, the encoding module 216 may include one or more HDSDI encoders for encoding the processed vertically polarized image and the processed horizontally polarized image received from the processing module 214. The encoding module 216 generates a final output that is in a form of a left HD image and a right HD image which may be further broadcasted for decoding by media or transmission devices.

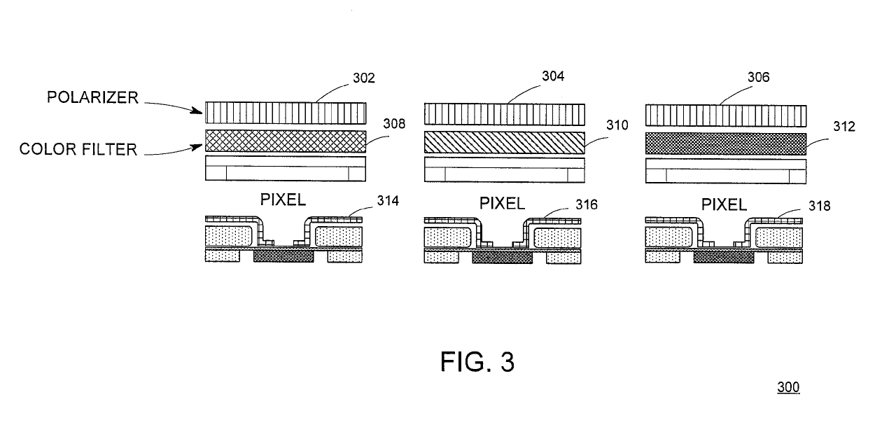

FIG. 3 illustrates a detailed construction for an imager 300 having a single output according to one or more embodiments of the present invention. The architecture 300 represents various arrays of pixels, polarizer and color filter for generating mixed polarization image. In an embodiment, the architecture 300 includes rows which have sequentially arranged RGB pixels, such as R pixel 314, G pixel 316, and B pixel 318 having respective color filters, such as R color filter 308, G color filters 310, or B color filter 312 on photodiodes. The architecture 300 further includes polarizer, such as 302, 304, and 306 corresponding to the R pixel 314, the G pixel 316, and the B pixel 318 respectively. In an embodiment, the pixels as illustrated herein are RGB pixels which produce single RGB output.

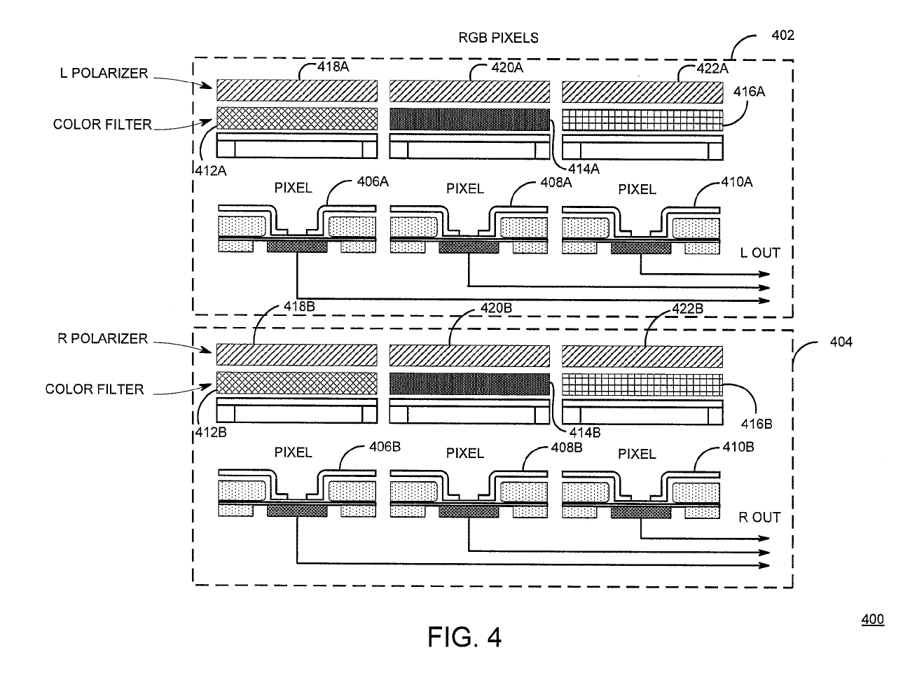

FIG. 4 illustrates a detailed construction for the imager 400 having a dual output according to one or more embodiments of the present invention. For illustration, architecture 400 for the imager 104 may be broadly described as a first portion 402 and a second portion 404. The first portion 402 represents various arrays of pixels, polarizer and color filter for generating separated vertically polarized image represented as L out. In an embodiment, the first portion 402 includes rows which have sequentially arranged RGB pixels, such as R pixel 406A, G pixel 408A, and B pixel 410A having respective color filters, such as R color filter 412A, G color filters 414A, or B color filter 416A on photodiodes. The first portion 402 further includes an L polarizer, such as 418A, 420A, and 422A corresponding to the R pixel 406A, the G pixel 408A, and the B pixel 410A respectively. In an embodiment, the pixels as illustrated herein are sequential RGB pixels which produce three indecent RGB outputs, such as L out (as shown by arrows).

In a similar manner, the complementary second portion 404 represents various arrays of pixels, polarizer and color filter for generating separated horizontally polarized image represented as R out. The second portion 404 includes rows which have sequentially arranged RGB pixels, such as R pixel 406B, G pixel 408B, and B pixel 410B having respective color filters, such as R color filter 412B, G color filter 414B, or B color filter 416B on photodiodes. The second portion 404 further includes an R polarizer, such as 418B, 420B, and 422B corresponding to the R pixel 406B, the G pixel 408B, and the B pixel 410B respectively. In an embodiment, the pixels as illustrated herein are sequential RGB pixels which produce three independent RGB outputs, such as R out (as shown by arrows).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

While the foregoing is directed to embodiments of the present invention, other and further embodiments of the invention may be devised without departing from the basic scope thereof, and the scope thereof is determined by the claims that follow.

1. A camera for obtaining a three-dimensional image comprising:
a lens module for capturing a beam of light;
a filter module for polarizing the beam of light into a first polarized beam of light and a second polarized beam of light;
a polarization array for generating a combined beam of light, the combined beam of light having the first polarized beam of light and the second polarized beam of light;
one or more imagers for capturing the first polarized beam of light and the second polarized beam of light from the combined beam of light, wherein the imager comprises one or more first polarized pixels for capturing the first polarized beam of light and one or more second polarized pixels for capturing the second polarized beam of light, wherein the first polarized beam and the second polarized beam are orthogonally polarized and providing a mixed polarization image having a first polarized image and a second polarized image as a single output; and
an output module for processing, and separating the mixed polarization image to produce the three-dimensional image.

2. The camera of claim 1, wherein the output module comprises a processing module for processing the mixed polarization image.

3. The camera of claim 1 wherein the output module outputs the three-dimensional image in a raw format.

4. The camera of claim 1, wherein the output module comprises a switch module to separate the mixed polarization image into a separated first polarized image and a separated second polarized image.

5. The camera of claim 1, wherein the output module comprises an encoding module for encoding the separated first polarized image and the separated second polarized image received from the switch module to generate the three-dimensional image.

6. The camera of claim 1, wherein the imager comprises one of a charge-coupled device (CCD) and a complementary metal-oxide-semiconductor (CMOS) sensor.

7. A camera for obtaining a three-dimensional image comprising:
a lens module for capturing a beam of light;
a filter module for polarizing the beam of light into a first polarized beam of light and a second polarized beam of light;
a polarization array for generating a combined beam of light, the combined beam of light having the first polarized beam of light and the second polarized beam of light;
one or more imagers for separating a left eye polarized image and a right eye polarized image from the beam of light, wherein the imager is comprised one or more left eye polarized pixels for capturing the left eye polarized image and one or more right eye polarized pixels for capturing the right eye polarized image, and providing the separated left eye polarized image to a first output and the separated right eye polarized image to a second output; and
an output module for processing and encoding the separated left eye polarized image and the separated right eye polarized image to produce the three-dimensional image.

8. The camera of claim 7, wherein the output module comprises a processing module for processing the separated left eye polarized image received from the first output and the separated right eye polarized image received from the second output.

9. The camera of claim 7, wherein the output module outputs the three-dimensional image in a raw format.

10. The camera of claim 7, wherein the processing module further applies a gamma correction, a white balance correction, and a color correction on the separated left eye polarized image and the separated right eye polarized image.

11. The camera of claim 7, wherein the output module comprises an encoding module for encoding the processed left eye polarized image and the processed right eye polarized image received from the processing modules to generate the three-dimensional image.

12. The camera of claim 7, wherein the imager comprises one of a charge-coupled device (CCD) and a complementary metal-oxide-semiconductor (CMOS) sensor.

13. A camera for obtaining a three-dimensional image comprising:
one or more imagers for capturing a first polarized beam of light and a second polarized beam of light from the combined beam of light, wherein the imager comprises one or more first polarized pixels for capturing the first polarized beam of light and one or more second polarized pixels for capturing the second polarized beam of light, wherein the first polarized beam and the second polarized beam are orthogonally polarized and providing a mixed polarization image having a first polarized image and a second polarized image as a single output.

14. The camera of claim 13 further comprising a processing module for processing the mixed polarization image received from the imager through the single output.

15. The camera of claim 13, wherein the mixed polarization image is output in a raw format.

16. The camera of claim 13 further comprising a switch module for subsequently separating the mixed polarization image into the first polarized image and the second polarized image.

17. The camera of claim 16, wherein the first polarized image and the second polarized image are separated on a basis of time multiplexing.

18. The camera of claim 13 further comprising an encoding module for encoding the separated first polarized image and the separated second polarized image received from the switch module.

19. The camera of claim 13 further comprising a lens control module operatively coupled with the imager for optimizing stereoscopic effects by adjusting separation and convergence of a lens module.

20. The camera of claim 13, wherein the imager comprises one of a charge-coupled device and a complementary metal-oxide-semiconductor sensor.
